(19) United States
(12) Patent Application Publication
(10) Pub. No.: US 2011/0000081 A1
(43) Pub. Date: Jan. 6, 2011

(54) Underwater cutting device for the handle of MTR plate-type feul

(76) Inventors: WEN-CHEN LEE, Taoyuan County (TW); Ling-Huan Chiao, Taoyuan County (TW)

Correspondence Address: MICHAEL LIN, 5F 79 Roosevelt Rd. Sec. 2, TAIPEI, 106, TW

(21) Appl. No.: 12/495,821

(22) Filed: Jul. 1, 2009

(51) Int. Cl. B26D 7/00; B26D 7/02; B26D 7/18

(52) U.S. Cl. 29/723; 83/169; 83/453; 83/701

(57) ABSTRACT

An underwater cutting device for the handle of MTR plate-type fuel has a housing that has an accommodation space for a feed pneumatic cylinder to drive a slidable base for lateral movement. And in front of the accommodation space there is a cutting chamber. A primary motor is located on the slidable base to drive the saw blade inside the cutting chamber to move and cut laterally with the slidable base that is driven by the feed pneumatic cylinder. A positioning block is located on the side with the housing and in the moving path of the saw blade. In the positioning block there is an accommodation space to hold the MTR plate-type fuel. Above the positioning block there is at least a pressing pneumatic cylinder to immobilize the MTR plate-type fuel and facilitate the saw blade to cut and remove the handle of MTR plate-type fuel. On the side of the bottom of the cutting chamber there is a filtration motor to absorb the metal cutting debris and deliver the debris through a conduit to the filter frame that contains filter for filtration.

### BACKGROUND OF THE INVENTION

1. Field of the Invention

The invention is related to the underwater cutting device for the handle of MTR (Material Test Reactor) plate-type fuel. Especially it refers to an underwater cutting device with a simplified cutting process, increased efficiency, improved processing quality, and ability to absorb and filter cutting debris to keep water clean, minimize operator radiation exposure, prevent contamination spreading and assure radiation protection and safety for operators.

2. Description of the Prior Art

MTR plate fuel is radioactive and the spent nuclear fuel rod is mainly stored in a water pond. The plate fuel structure is shown in FIG. 1 and mainly comprises: fuel plates, side plates and handles. Each set of MTR plate fuel is composed of 10 pieces fuel plates that are parallelly inserted into the side plate. The dimensions (including protective cover) for each fuel plate are 63.55 cm×7.05 cm×0.25 cm. The side plate is marked with identification number. The two handles are connected at the terminals of the two side plates, so the final dimensions for each set of MTR plate fuel 5 are 100.3 cm×7.6 cm×7.6 cm and the total weight is approximately 5190 g. Both handles are made of aluminum to reduce the volume and weight for the fuel during loading and shipping and the fuel retreatment cost. Besides, to minimize operator radiation exposure and prevent contamination spreading, it is necessary to cut and remove the handles in the 6-meter-deep water pond and still maintain the holding strength between the side plate and each fuel plate without the risk of being disassembled or damaged due to the absence of handles or other operation.

However, current cutting process uses the traditional cutting tool that is modified to be waterproof. Since it is not originally designed for the above-mentioned underwater cutting operation, in general, its process is complicated and not smooth. It adds operational difficulty that not only affects efficiency but also increases operator radiation exposure.

In view of the drawbacks for the traditional cutting device for the handle of MTR plate-type fuel, the inventor has sought improvement and come up with the invention.

### SUMMARY OF THE INVENTION

The main objective for the invention is to provide an underwater cutting device for the handle of MTR plate-type fuel that is specially designed automation equipment for underwater cutting for the handle of MTR plate-type fuel. Therefore, it can effectively simplify the cutting process, increase efficiency, improve processing quality, absorb and filter cutting debris to keep the pond water clean, minimize operator radiation exposure, prevent contamination spreading and assure radiation protection and safety for operators.

Another objective for the invention is to provide an underwater cutting device for the handle of MTR plate-type fuel that uses automation to prevent dimensional error due to improper operation and assure the holding strength between the side plate and each fuel plate without the risk of being disassembled or damaged due to the absence of handles or other operation.

To attain the above-mentioned objectives, the technical approaches include: a housing that has an accommodation space in which there is a feed pneumatic cylinder to drive a slidable base for lateral movement and in front of which there is a cutting chamber; a primary motor on the slidable base to drive the saw blade in the cutting chamber; a positioning block on the side of the housing and in the moving path of the saw blade and a holding tank for the MTR plate-type fuel in the positioning block.

Please refer to the attached figures for a complete understanding of the detailed structure, application principles, functions and benefits for the invention.

### BRIEF DESCRIPTION OF THE DRAWINGS

FIG. 1 is the structural diagram for a traditional MTR plate-type fuel.

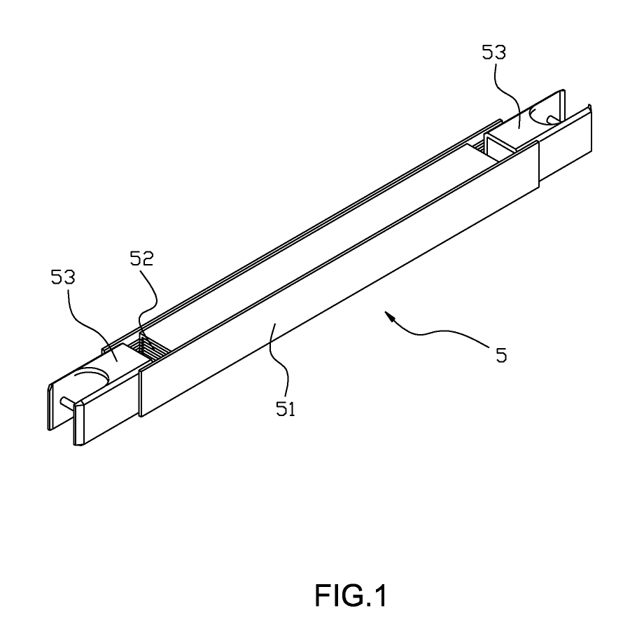

FIG. 2 is the three-dimensional structural diagram for the invention.

FIG. 3 is the assembly diagram for the invention.

FIG. 4 is the planar structural diagram for the invention.

FIG. 5 is the illustration for the cutting action for the invention.

### DETAILED DESCRIPTION OF THE INVENTION

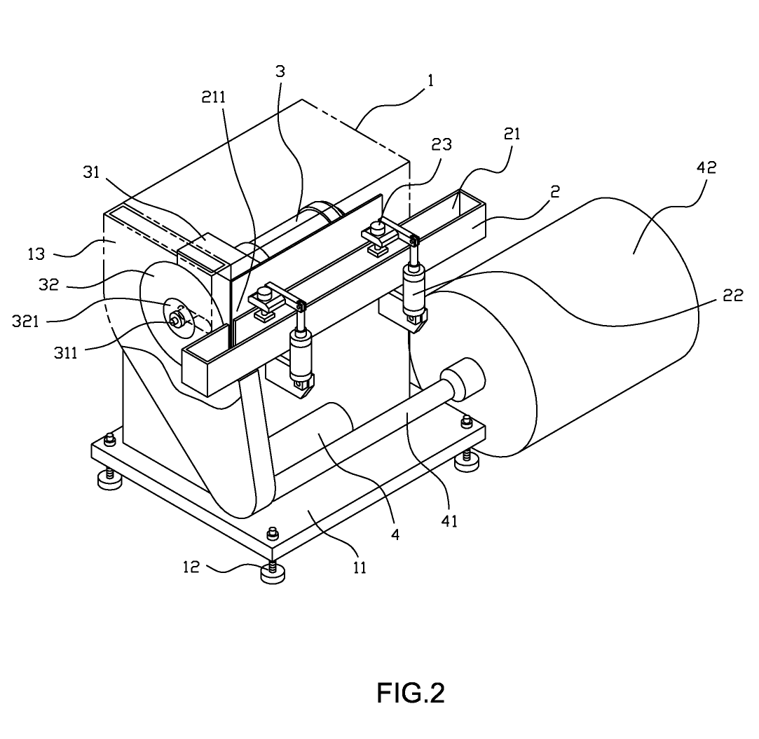

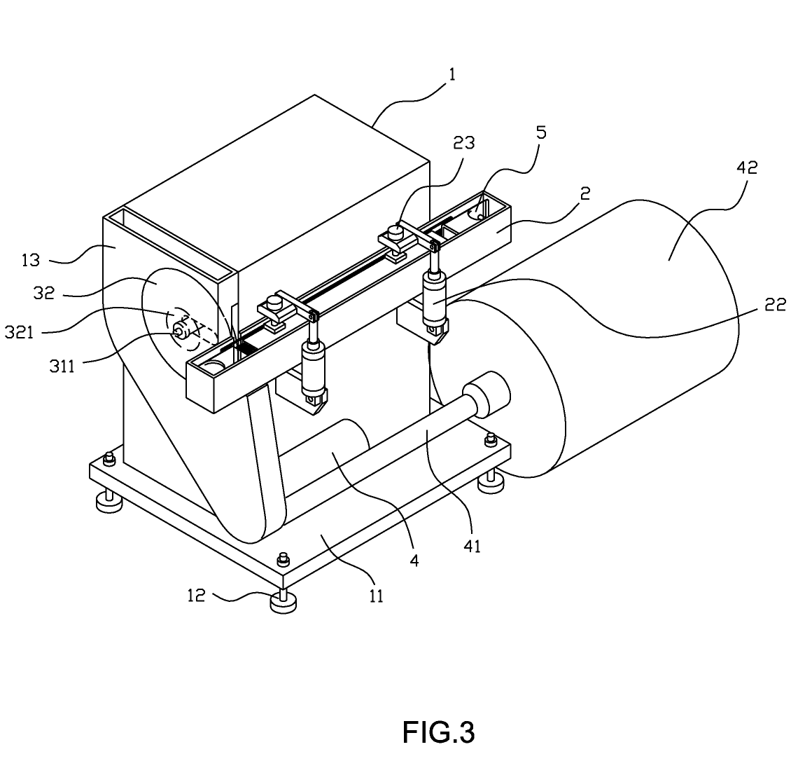

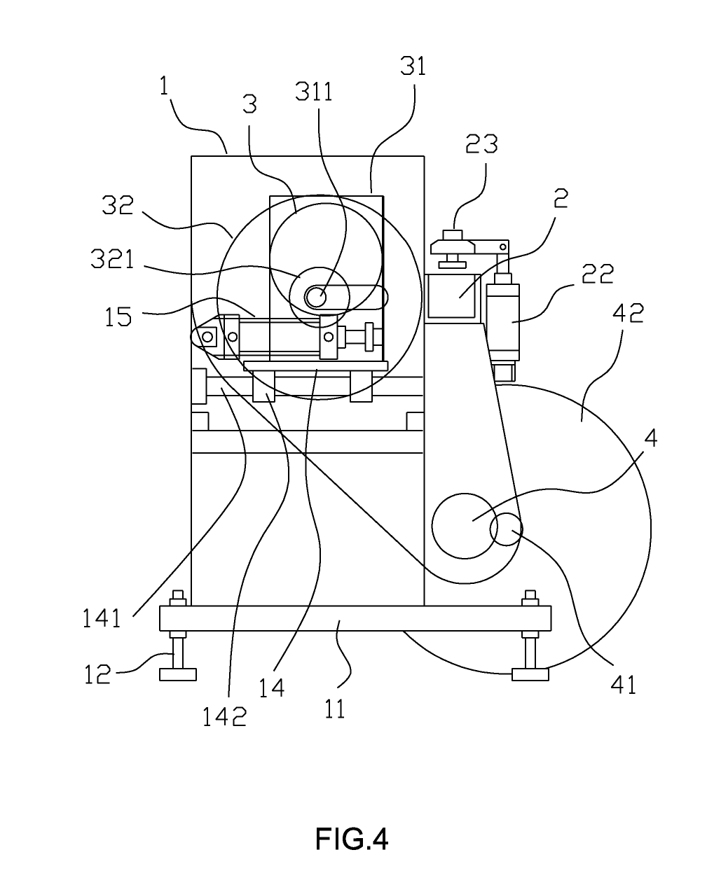

From FIG. 2 to FIG. 4, it can be clearly found that the structure for the invention mainly comprises: a housing 1, a positioning block 2, a primary motor 3 and a filtration motor 4. The housing 1 is located on a base 11 around which there are several height-adjustable feet 12. There is an accommodation space in the housing 1 in which there is a slidable base 14. There are several bearings 142 on the bottom of the slidable base 14 and they can be coupled with several lateral guide rods 141. Besides, between the inner walls of the slidable base 14 and the housing 1 there is a feed pneumatic cylinder 15. In front of the accommodation space, there is a cutting chamber 13. The positioning block 2 is located on the side with the housing 1 and contains a holding tank 21 that can accommodate MTR plate-type fuel 5. The holding tank 21 has an opening 211 on the side with the cutting chamber 13. Further, there is at least one positioning block pneumatic cylinder 22 on the side with the positioning block 2. The output shaft of the positioning block pneumatic cylinder 22 has another pressing pneumatic cylinder 23, which effectively immobilizes the MTR plate-type fuel 5. The primary motor 3 is located on the slidable base 14 and its output section is integrated with a reduction gearbox 31, through which an output shaft 311 sticks into the cutting chamber 13. At the terminal of the output shaft 311 there is a saw blade press plate 321 to tighten the saw blade 32. The filtration motor 4 is located on the side of the bottom of the cutting chamber 13 and connects through a conduit 41 to a filter frame 42 that contains filters.

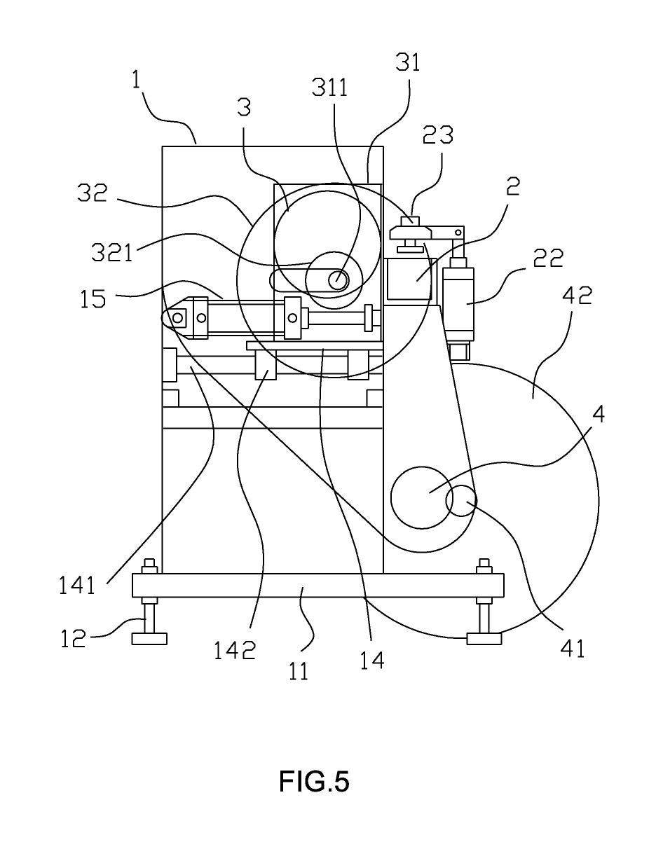

From FIG. 5 it can be known that the operation of the invention starts with placing the MTR plate-type fuel 5 into the holding tank 21 and immobilizing the MTR plate-type fuel 5 by the action of the positioning block pneumatic cylinder 22 and the pressing pneumatic cylinder 23. Then, the primary motor 3 through the reduction gearbox 31 drives the saw blade 32 to rotate and the feed pneumatic cylinder 15 also drives the slidable base 14 to slide, allowing the saw blade 32 to stick out from the opening 211 into the holding tank 21 to cut the MTR plate-type fuel 5. The metal cutting debris is collected by the filtration motor 4 and delivered through the conduit 41 to the filter frame 42 for filtration by the filter inside. After that, the positioning block pneumatic cylinder 22 and the pressing pneumatic cylinder 23 will release the MTR plate-type fuel 5 to facilitate the removal of the cut MTR plate-type fuel 5.

The invention through the above-mentioned positioning block 2 can facilitate the cutting by positioning the MTR plate-type fuel 5. It also utilizes automation to simplify the entire process to reduce processing cost and increase operation efficiency.

From the above, it can be found that the invention for an underwater cutting device for the handle of MTR plate-type fuel has the industrial usefulness, novelty and progressiveness because it can facilitate a simple cutting operation, increase efficiency, improve processing quality, absorb and filter cutting debris to keep water clean, minimize operator radiation exposure, prevent contamination spreading and assure radiation protection and safety for operators.

The description above is only a preferred embodiment for the invention, which is not to limit the application scope for the invention. Those equivalent alteration and modifications within the range of the claims by the invention shall all be covered within the range of the claims.

What is claimed is:

1. An underwater cutting device for a handle of MTR plate-type fuel comprising:
a housing that has an accommodation space in which there is a feed pneumatic cylinder to drive a slidable base for lateral movement and in front of which there is a cutting chamber;
a primary motor on the slidable base to drive the saw blade in the cutting chamber; and
a positioning block on the side of the housing and in the moving path of the saw blade and a holding tank in the positioning block that can hold the MTR plate-type fuel.

2. According to claim 1 for an underwater cutting device for the handle of MTR plate-type fuel, above the positioning block there is at least a pressing pneumatic cylinder to immobilize the MTR plate-type fuel.

3. According to claim 2 for an underwater cutting device for the handle of MTR plate-type fuel, on the side with the positioning block there is at least a positioning block pneumatic cylinder and the pressing pneumatic cylinder is driven up and down by the positioning block pneumatic cylinder.

4. According to claim 1 for an underwater cutting device for the handle of MTR plate-type fuel, on the side of the bottom of the cutting chamber there is a filtration motor that though a conduit connects to a filter frame with filter inside.

5. According to claim 1 for an underwater cutting device for the handle of MTR plate-type fuel, the output section of the primary motor is integrated with a reduction gearbox, through which an output shaft sticks into the cutting chamber and at the terminal of the output shaft there is a saw blade press plate to tighten the saw blade.

6. According to claim 4 for an underwater cutting device for the handle of MTR plate-type fuel, the output section of the primary motor is integrated with a reduction gearbox, through which an output shaft sticks into the cutting chamber and at the terminal of the output shaft there is a saw blade press plate to tighten the saw blade.

7. According to claim 1 for an underwater cutting device for the handle of MTR plate-type fuel, there are several bearings on the bottom of the slidable base and they can be coupled with several lateral guide rods.

8. According to claim 1 for an underwater cutting device for the handle of MTR plate-type fuel, the housing is located on a base around which there are several height-adjustable feet.

9. According to claim 1 for an underwater cutting device for the handle of MTR plate-type fuel, the holding tank of the positioning block has an opening on the side with the cutting chamber for the saw blade to stick in.
